(19) United States
(12) Patent Application Publication
(10) Pub. No.: US 2012/0195055 A1
(43) Pub. Date: Aug. 2, 2012

(54) LIGHTING FIXTURE WITH ADJUSTING WEIGHT STRUCTURE

(76) Inventors: Michael Prichard, Carlisle, MA (US); Henry Minsky, Newton, MA (US); Milan Minsky, Newton, MA (US)

(21) Appl. No.: 13/017,190

(22) Filed: Jan. 31, 2011

(51) Int. Cl. F21V 21/28; F21V 21/26

(52) U.S. Cl. 362/401

(57) ABSTRACT

A lighting fixture includes a main arm and a cantilever that is attached to main arm. The cantilever has mounted at one end a lamp and at the other end a weight. The cantilever is mounted to the main arm. The weight is attached to the cantilever in such a way as to allow the cantilever to rotate so at to cause to the lamp to move from one position to another position.

### BACKGROUND

Certain types of lamps may include a lighting element mounted on an arm pivotable with relation to a main support arm. These lamps may include springs and compression fittings which may be adjusted by screws or knobs to control the positioning of the lighting element. To adjust the position of the arm including the lighting element, force may be applied to overcome friction provided by the spring and compression fittings between the arm including the lighting element and the main arm. Alternatively, the compression fittings may be loosened via an adjusting knob to allow movement of the arm including the lighting element relative to the main arm. The range of motion of the arm including the lighting element relative to the main arm in these types of lamps is typically limited to a specific range—one cannot easily flip the arm with the lighting element to the opposite side of the main support arm without turning the entire lamp 180 degrees.

### SUMMARY

Aspects and embodiments of the present disclosure relate to an adjustable lighting fixture that allows for adjustment of the position of a lamp and utilizes a repositionable weight to balance an arm including the lamp on a main support arm. Aspects and embodiments of the present disclosure provide for a lighting fixture that includes elements which facilitate easy movement and adjustment of a lamp about a wide range of motion.

Aspects and embodiments of the present disclosure comprise a lighting fixture having a main arm and a cantilever attached to main arm. The cantilever may include a lamp mounted proximate a first end and a weight mounted proximate a second end. The cantilever may be mounted to one side of the main arm. The weight may be attached to the cantilever on the side of the cantilever opposite the main arm in such a way as to allow the cantilever to rotate about a pivot point on the main arm.

The main arm may also be adapted to adjust in length, thus allowing the lighting fixture to attain different heights. The main arm may be mounted to a base designed to stabilize the overall light fixture and to offer another degree of movement by rotating the main arm relative to the base.

The lamp may be interchangeable with different lamps with different masses. The weight may be adjusted either by movement or by exchanging the weight for a second weight with a different mass to compensate for the change in mass of the lamp.

In accordance with one aspect, there is provided a lighting fixture. The lighting fixture comprises a main arm and a cantilever. The cantilever has a first end, and a second end. The cantilever is pivotally attached by a cantilever pivot mount to the main arm at a point between the first end and the second end. A first lamp device is disposed on the cantilever and pivotally mounted on the cantilever proximate the first end of the cantilever with a lamp pivot mount. A first balance weight having a mass is disposed on the cantilever. The mass is selected to create a substantially balanced state of the cantilever about the cantilever pivot mount.

In accordance with some embodiments, the lamp device is disposed on a first side of the cantilever, and the first balance weight is disposed substantially on a second side of the cantilever.

In accordance with some embodiments, the cantilever is pivotally attached by the cantilever pivot mount to the main arm on the first side of the cantilever.

In accordance with some embodiments, the first balance weight is positioned on the cantilever to provide for the cantilever to transition through a range of motion from a first position to a second position. In the first position, the second end of the cantilever may be positioned on a first side of the main arm and in the second position, the second end of the cantilever may be positioned on a second side of the main arm.

In accordance with some embodiments, the main arm is adjustable in length.

In accordance with some embodiments, the lighting fixture further comprises a base. The main arm may be adapted to mount to the base and the base may be adapted to maintain the light fixture in a substantially stable upright position.

In accordance with some embodiments, the main arm is further adapted to rotate relative to the base about an axis parallel to a length of the main arm.

In accordance with some embodiments, the lighting fixture further comprises electrical conductors adapted to provide power to the lighting fixture. In accordance with some embodiments, the electrical conductors are adapted to provide power to the first lamp device. In accordance with some embodiments, the main arm and the cantilever are adapted to enclose the electrical conductors.

In accordance with some embodiments, the first lamp device has a first mass and the lamp pivot mount is configured to facilitate the replacement of the first lamp device with a second lamp device having a second mass, the first mass being different from the second mass.

In accordance with some embodiments, the weight mount is adapted to facilitate replacement of the first balance weight with a second balance weight.

In accordance with some embodiments, replacement of the first balance weight with the second balance weight upon replacement of the first lamp device with the second lamp device maintains the substantially balanced state of the cantilever about the cantilever pivot mount.

In accordance with some embodiments, the cantilever is adapted to facilitate replacement of the first lamp device with a second lamp device. In accordance with some embodiments, the second lamp device is substantially the same as the first lamp device.

In accordance with some embodiments, the mass is selected to create a substantially balanced state of the cantilever about an axis perpendicular to an axis of rotation of the cantilever about the main arm.

In accordance with another aspect of the present disclosure, there is provided a lighting fixture including a main arm and a cantilever having a first end and a second end, the cantilever being pivotally attached by a cantilever pivot mount to the main arm at a point between the first end and the second end. The lighting fixture further includes a first lamp device disposed on the first side of the cantilever and pivotally mounted on the cantilever proximate the first end of the cantilever with a lamp pivot mount, and a first balance weight disposed on the cantilever, the first balance weight being attached to the cantilever by a weight mount which provides for adjustment of a position of the first balance weight along a length of the cantilever between the cantilever pivot mount and the second end of the cantilever to create a substantially balanced state of the cantilever about the cantilever pivot mount.

In accordance with another aspect of the present disclosure, there is provided a method of adjusting a lighting fixture. The method comprises providing a lighting fixture including a first lamp removably attached proximate a first end of a cantilever arm, a weight removably attached proximate a second end of the cantilever arm, and a cantilever pivot pivotally attaching the cantilever arm to a main arm. The method further comprises removing the first lamp from the cantilever arm, attaching a second lamp of a different mass than the first lamp to the cantilever arm, and one of adjusting a position of the weight on the cantilever arm or replacing the weight with a second weight, such that the cantilever arm is balanced about the cantilever pivot.

### BRIEF DESCRIPTION OF THE DRAWINGS

FIG. 1 is a side elevational schematic view of a lighting fixture in accordance with an embodiment of the present disclosure;

FIG. 2 is a side elevational schematic view of a lighting fixture in accordance with another embodiment of the present disclosure;

FIG. 3 is a front elevational schematic view of the lighting fixture illustrated in FIG. 1;

FIG. 4A is a side elevational schematic view of the lighting fixture illustrated in FIG. 1 with a cantilever arm in a first position;

FIG. 4B is a side elevational schematic view of the lighting fixture illustrated in FIG. 1 with the cantilever arm in a second position;

FIG. 4C is a side elevational schematic view of the lighting fixture illustrated in FIG. 1 with the cantilever arm in a third position;

FIG. 5 is a front elevational schematic view of the lighting fixture illustrated in FIG. 1 with a lamp and a weight of the lighting fixture illustrated in FIG. 1 replaced with a second lamp and a second weight;

FIG. 6 is a front elevational schematic view of the lighting fixture illustrated in FIG. 4 with the weight of the lighting fixture shown in FIG. 5 replaced with a third weight; and

FIG. 7 is a perspective view of a lighting fixture in accordance with another embodiment of the present disclosure.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

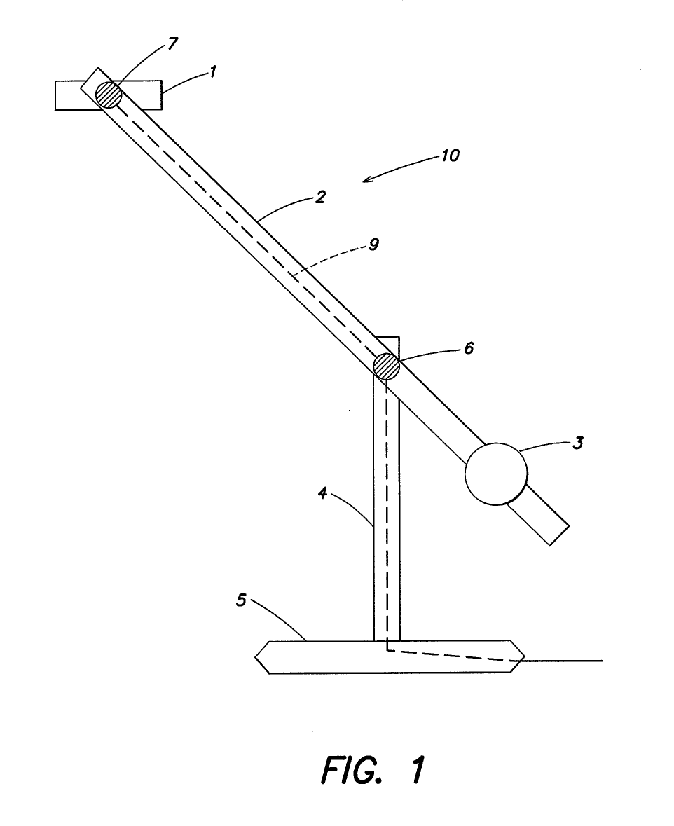

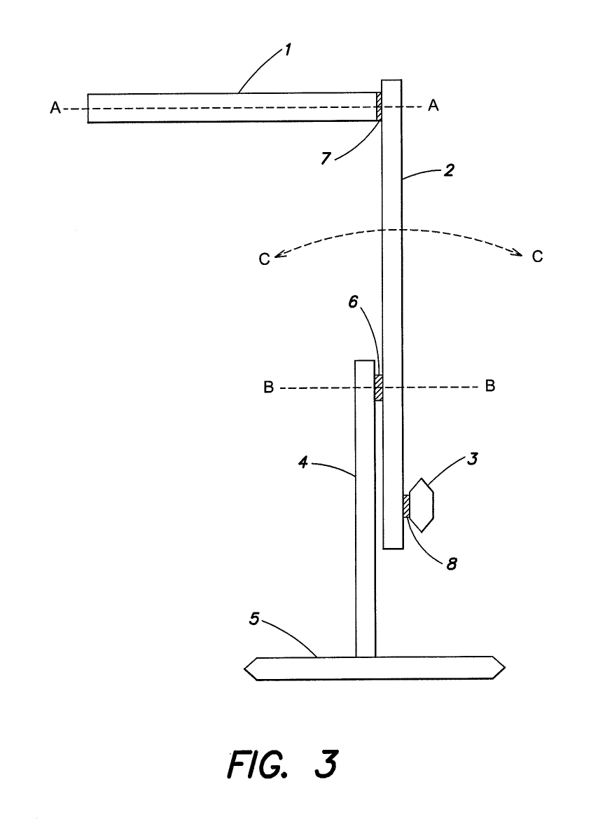

Referring to FIG. 1, there is schematically illustrated an embodiment of a lighting fixture, generally indicated at 10, in accordance with the present disclosure. In one embodiment, the lighting fixture 10 includes a light source 1, also referred to herein as a “lamp device,” a cantilever 2, a weight 3, a main arm 4, and a base 5. The light source 1 is mounted to the cantilever 2 proximate a first end of the cantilever using a lamp pivot mount 7. The lamp pivot mount 7 allows the transfer of electrical power from the base 5 to light source 1, through electrical conductors 9, which may be located internal to the base 5, main arm 4 and cantilever 2. The lamp pivot mount 7 also provides for adjustment of the projection angle of the light source 1 by providing for the light source to pivot about an axis generally parallel to a length of the light source 1 (for example, the axis A-A indicated in FIG. 3). The light source 1 may comprise any one or more of a variety of different lighting elements such as incandescent, florescent, or LED lighting elements or a combination of different lighting elements.

The lamp pivot mount 7 is attached to the cantilever 2. The cantilever 2 may be constructed of a substantially rigid material such as aluminum, although aspects and embodiments of the present disclosure are not limited to any particular material(s) of construction unless explicitly set forth in the claims. The weight 3 may be mounted on the cantilever proximate a second end of the cantilever. The cantilever pivot mount 6 is disposed on the cantilever 2 between the light source 1 and the weight 3 to allow attachment of the cantilever 2 to the main arm 4. As shown in FIG. 3, the cantilever 2 is attached to the main arm on the same side of the cantilever 2 as the light source 1.

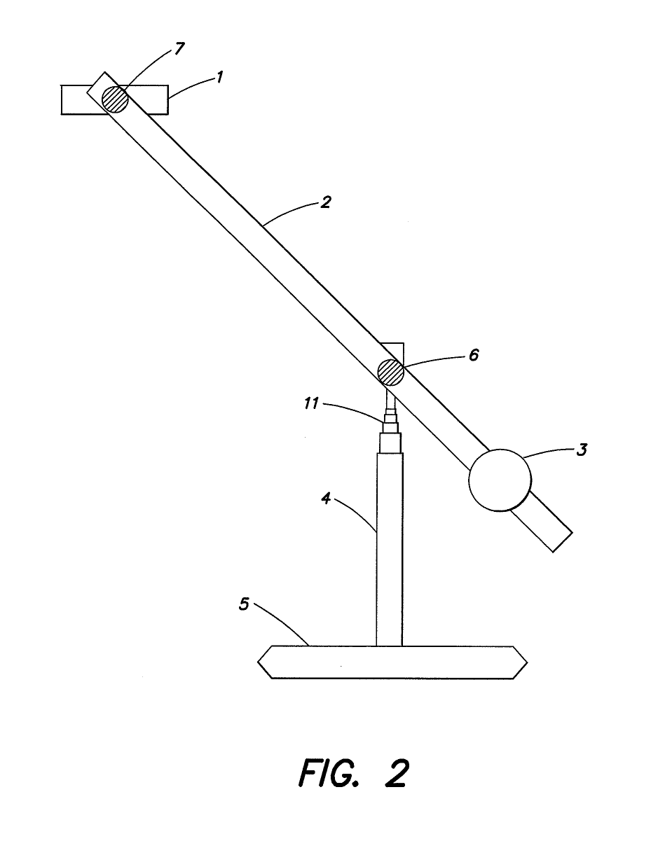

The weight 3 is attached with a position adjustable weight mount 8 to the cantilever. The weight 3 may have a mass selected such that the light source 1 and the weight 3 in combination exist in a substantially balanced state on cantilever 2 about the cantilever pivot mount 6. The cantilever pivot mount 6 can be adapted to provide friction to hold the cantilever 2 in a position selected by the user. For example, the cantilever may include one or more friction plates which may be tightened against one another using a tightening screw or knob and which may provide a frictional force opposing pivoting of the cantilever 2 relative to the main arm 4. The main arm and/or the cantilever may be extendable, by the inclusion of one or more telescoping sections 11, such as that illustrated in FIG. 2

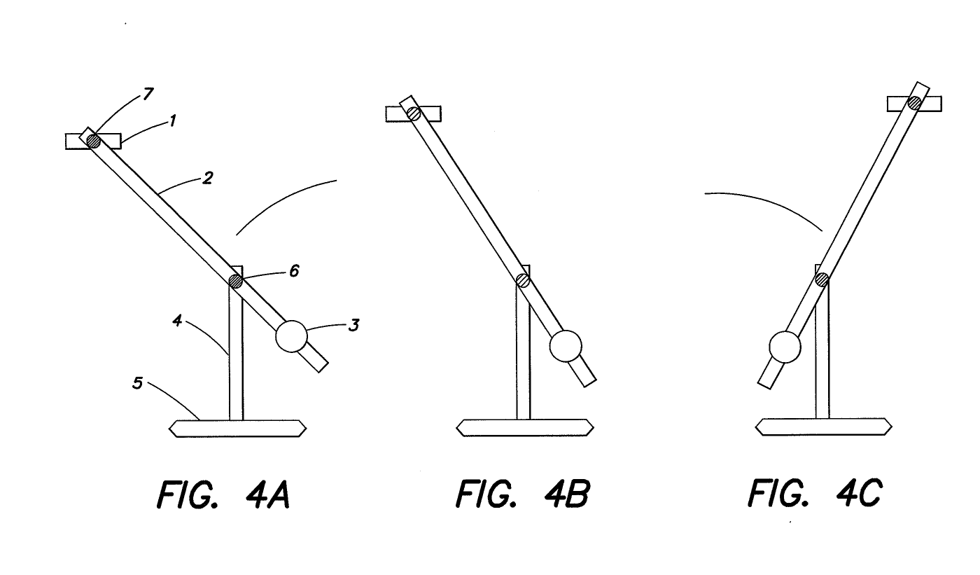

The weight 3 may be positioned and/or sized so that the cantilever 2 can rotate freely about the cantilever pivot mount 6 (for example, about axis B-B indicated in FIG. 3). The weight 3 may have a shape where predominately all of the weight 3 is disposed on the side of the cantilever 2 opposite the main arm 4 so that the cantilever 2 can rotate about the cantilever pivot mount 6 without the weight 3 impacting the main arm 4. As illustrated in FIGS. 4A, 4B, and 4C, this allows the cantilever to rotate about the cantilever pivot mount 6 from a position with the second end of the cantilever on one side of the main arm 4 (FIG. 4A) through an intermediate position (FIG. 4B) and to a position in which the second end of the cantilever is on the other side of the main arm 4 (FIG. 4C). The main arm 4 may be attached to a base 5 that has sufficient size and mass to provide for the stable placement of the fixture.

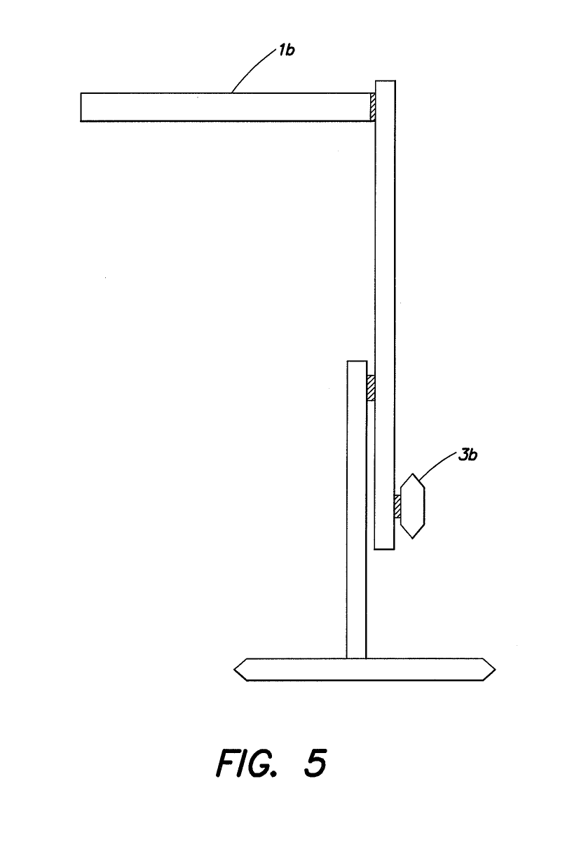

The lamp pivot mount 7 may be adapted to allow easy removal of the light source 1. This facilitates repair, replacement, or change of the light source 1. Changing out the light source 1 allows use of a light source 1b (FIG. 5) that is of a different nature (for example, replacing a LED lighting element for an incandescent lighting element), size (80 watt for 40 watt), or even a different type (circular, linear, magnified, etc.)

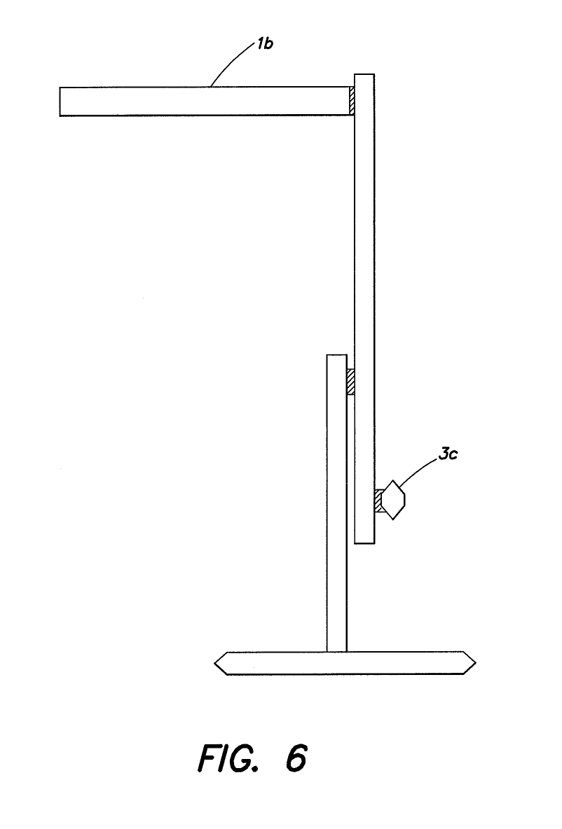

The weight mount 8 may be adapted to facilitate easy removal of the weight 3. This facilitates change of the weight 3 to a different weight 3b (FIG. 5) or 3c (FIG. 6) as needed to create a substantially balanced state between the new light source 1b and the weight 3, 3b, 3c on the cantilever 2. The weight mount 8 may also be adapted to facilitate movement of the weight 3, 3b, 3c to a different position along a length of the cantilever 2 as an alternative mechanism to create a balanced state between the new light source 1b and the weight 3, 3b, 3c. For example the weight mount may include a screw (not shown) passing through the body of the weight mount 8 and contacting a surface of the cantilever 2. Upon loosening of the screw in the weight mount 8, the weight mount 8 may be moved along a length of the cantilever 2 and then secured in place by a tightening of the screw against the surface of the cantilever 2. Thus, as noted, if the light source is changed, the weight can be adjusted by moving to a new location or by exchanging the weight with a different weight so as to create a balance state appropriate for the light source. In some embodiments, the weight mount 8 may be integral with the weight 3, for example as a through hole in the weight 3 through which a retaining screw may pass such that it may be tightened against the cantilever to hold the weight 3 in place.

In some embodiments, a weight 3 may be chosen to balance a weight of the lighting element 1 in a side-to-side direction about the main arm. For example a weight may be selected with a mass sufficient to balance a weight of the lighting element 1 such that there is no rotational force acting on the cantilever 2 about the cantilever pivot mount 6 in a direction of one of the dotted curved arrows C shown in FIG. 3.

The base 5, main arm 4, cantilever pivot mount 6, cantilever 2, lamp pivot mount 7, and light source 1 may be adapted to deliver power to the light source 1. For example, a pair of wire conductors 9 (see FIG. 1) may be positioned in a channel in the base 5, main arm 4, and cantilever 2, with holes in the cantilever pivot mount 6 and lamp pivot mount 7 to provide for passage of the wire conductors 9 into the interior of the cantilever 2 and to the light source 1. An electrical switch (not shown) may be present, for example, on the base 5 of the lighting fixture to control the flow of power through the electrical conductors 9. The cantilever pivot mount 6 and lamp pivot mount 7 may further be adapted to use flexible contacts that are in electrical contact with conductors so as to allow free rotation of the cantilever 2 and/or light source 1 without the provision of a conductor channel.

The light fixture may be formed out of a metal, such as aluminum, with certain parts, such as cantilever pivot mount 6 and weight mount 8 utilizing materials having improved wear properties such as steel. One of ordinary skill in the art would appreciate the variety of materials that could be utilized in fabrication of the light fixture.

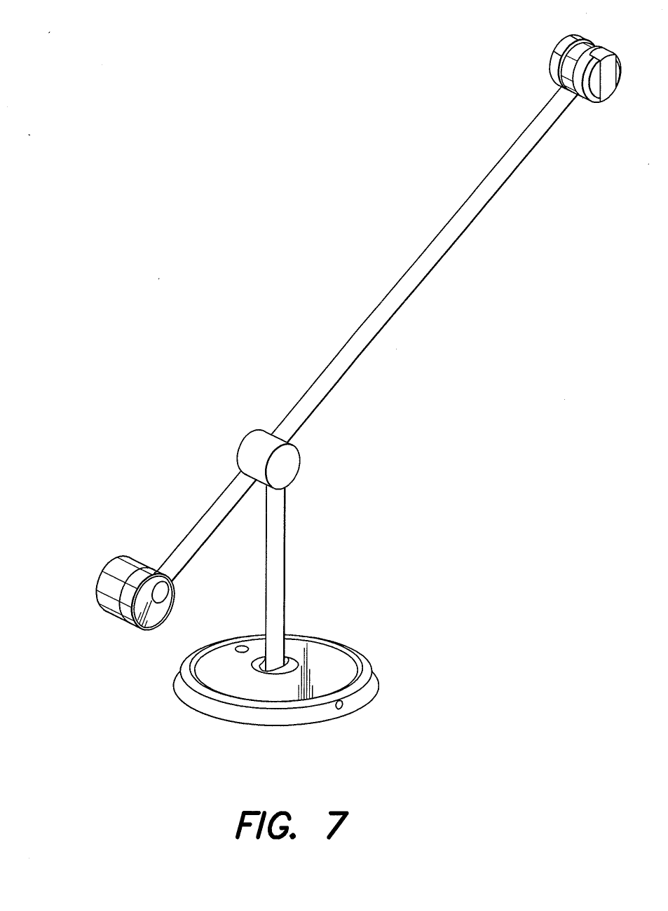

Aspects and embodiments of the present disclosure may be modified without departing from the spirit and scope of the disclosure. For instance, the size of the lighting fixture can be scaled down to be utilized as a disk lamp as illustrated by the embodiment of FIG. 7 or scaled up to be utilized as a floor lamp.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A lighting fixture comprising:
a main arm;
a cantilever having a first end and a second end, the cantilever being pivotally attached by a cantilever pivot mount to the main arm at a point between the first end and the second end;
a first lamp device disposed on the cantilever and pivotally mounted on the cantilever proximate the first end of the cantilever with a lamp pivot mount; and
a first balance weight disposed on the cantilever, the first weight having a mass selected to create a substantially balanced state of the cantilever about the cantilever pivot mount.

2. The lighting fixture of claim 1, wherein the lamp device is disposed on a first side of the cantilever, and the first balance weight is disposed substantially on a second side of the cantilever.

3. The lighting fixture of claim 2, wherein the cantilever is pivotally attached by the cantilever pivot mount to the main arm on the first side of the cantilever.

4. The lighting fixture of claim 1, wherein the first balance weight is positioned on the cantilever to provide for the cantilever to transition through a range of motion from a first position to a second position.

5. The lighting fixture of claim 4, wherein in the first position, the second end of the cantilever is positioned on a first side of the main arm and wherein in the second position, the second end of the cantilever is positioned on a second side of the main arm.

6. The lighting fixture of claim 1, wherein the main arm is adjustable in length.

7. The lighting fixture of claim 1, further comprising a base, wherein the main arm is adapted to mount to the base, the base adapted to maintain the light fixture in a substantially stable upright position.

8. The lighting fixture of claim 1, further comprising electrical conductors adapted to provide power to the lighting fixture.

9. The lighting fixture of claim 8, further comprising electrical conductors configured to provide power to the first lamp device.

10. The lighting fixture of claim 8, wherein the main arm and the cantilever are adapted to enclose the electrical conductors.

11. The lighting fixture of claim 10, wherein the first lamp device has a first mass and the lamp pivot mount is configured to facilitate the replacement of the first lamp device with a second lamp device having a second mass, the first mass being different from the second mass.

12. The lighting fixture of claim 11, wherein the weight mount is adapted to facilitate replacement of the first balance weight with a second balance weight.

13. The light fixture of claim 12, wherein replacement of the first balance weight with the second balance weight upon replacement of the first lamp device with the second lamp device maintains the substantially balanced state of the cantilever about the cantilever pivot mount.

14. The lighting fixture of claim 1, wherein the cantilever is adapted to facilitate replacement of the first lamp device with a second lamp device.

15. The lighting fixture of claim 1, wherein the mass is selected to create a substantially balanced state of the cantilever about an axis perpendicular to an axis of rotation of the cantilever about the main arm.

16. A lighting fixture comprising:
a main arm;
a cantilever having a first end and a second end, the cantilever being pivotally attached by a cantilever pivot mount to the main arm at a point between the first end and the second end;
a first lamp device disposed on the first side of the cantilever and pivotally mounted on the cantilever proximate the first end of the cantilever with a lamp pivot mount; and
a first balance weight disposed on the cantilever, the first balance weight being attached to the cantilever by a weight mount which provides for adjustment of a position of the first balance weight along a length of the cantilever between the cantilever pivot mount and the second end of the cantilever to create a substantially balanced state of the cantilever about the cantilever pivot mount.
